(19) United States
(12) Patent Application Publication
(10) Pub. No.: US 2010/0251306 A1
(43) Pub. Date: Sep. 30, 2010

(54) METHOD AND APPARATUS FOR PROVIDING ELECTRONIC PROGRAM GUIDE

(75) Inventor: Zhang-hoon OH, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/550,448

(22) Filed: Aug. 31, 2009

(30) Foreign Application Priority Data
Mar. 24, 2009 (KR) 10-2009-0024998

(51) Int. Cl. H04N 5/445

(52) U.S. Cl. 725/51

(57) ABSTRACT

Provided are a method and apparatus for generating an electronic program guide (EPG). A method of generating a personalized EPG includes receiving at least one first EPG of scheduled contents from a content provider, detecting whether there is recording information on each of the scheduled contents, generating a second EPG using the detected recording information on each of the scheduled contents and the at least one first EPG, and transmitting the second EPG to a server.

### CROSS-REFERENCE TO RELATED PATENT APPLICATION

This application claims priority from Korean Patent Application No. 10-2009-0024998, filed on Mar. 24, 2009, in the Korean Intellectual Property Office, the disclosure of which is incorporated herein in its entirety by reference.

### BACKGROUND OF THE INVENTION

1. Field of the Invention

Methods and apparatuses consistent with the present invention relate to providing an electronic program guide (EPG).

2. Description of the Related Art

The need for an electronic program guide (EPG) has gradually increased in the environment that provides a lot of broadcasting services by ground wave, satellite, and cable. In general, a user may manipulate an EPG generating system, such as a personal video recorder (PVR) or a television (TV), using an apparatus, such as a remote controller, and receive information on the EPG.

A TV may receive information on an EPG of each broadcasting station at predetermined time intervals and store the information in a predetermined memory region. The stored information on the EPG may be displayed to allow a user to tune a specific channel. Also, the user may search for a desired program according to a date, a time slot, and a broadcasting station using an output menu of the EPG.

### SUMMARY OF THE INVENTION

Exemplary embodiments of the present invention provide a method and apparatus for providing an electronic program guide (EPG).

According to an aspect of the present invention, there is provided a method of generating a personalized EPG. The method includes: receiving at least one first EPG from a content provider; detecting whether there is recording information on each of contents scheduled for the at least one first EPG; generating a second EPG using the detected recording information on each of the contents and the at least one first EPG; and transmitting the second EPG to a server.

The method may further include detecting whether there is additional information to be updated among additional information on the contents scheduled for the at least one first EPG. In this case, the second EPG may be generated using the recording information and the additional information to be updated.

The detecting whether there is the additional information to be updated may include: crawling information on the contents scheduled for the at least one first EPG from the content provider; and searching for previously uncrawled additional information or additional information, which differs from previously crawled additional information, as the additional information to be updated, based on the crawling result.

The detecting whether there is the recording information may be performed using a first processing unit, and the information on the contents scheduled for the at least one first EPG from the content provider may be crawled using one of the first processing unit and a second processing unit that perform operations in an alternative way.

The first processing unit may generate and store the recording information, while the second processing unit may manage the at least one first EPG and reproduce the contents. In this case, the crawling operation may be performed by one of the first and second processing units, which performs operations to consume smaller resources at present.

The crawling operation may be performed after recording of at least one of the contents is reserved or completed.

At least one of the first EPG and the second EPG may be configured in a microformat. In this case, detecting whether there is the recording information may be performed based on the microformat included in the at least one first EPG.

The generating the second EPG may include inserting at least one of a marker and text, which indicate the recording information, into the at least one first EPG or adding an addition region containing the recording information to the at least one first EPG.

The method of generating the personalized EPG may further include generating positional information including a position of additional information on the contents in the at last one first EPG. In this case, the second EPG may be generated based on the generated positional information.

The second EPG may be generated based on performance of an external apparatus that will use the second EPG.

The recording information may include information on at least one selected from the group consisting of recording completion, recording stoppage, recording cancellation, recording reservation, and reserved recording cancellation of a content and a content-recorded apparatus.

The receiving the at least one first EPG may include receiving at least one of a first EPG configured in a hypertext markup language (HTML) format and a first EPG configured in an extensible markup language (XML) format.

According to another aspect of the present invention, there is provided an EPG generation apparatus for providing a personalized EPG. The apparatus includes: a processing unit configured to receive at least one first EPG from a content provider and detect whether there is recording information on each of contents scheduled for the at least one first EPG; an EPG generation unit configured to generate a second EPG using the detected recording information on each of the contents and the at least one first EPG; and a transmission unit configured to transmit the second EPG to a server.

The apparatus may further include a positional information generation unit configured to generate positional information including a position of additional information on the contents in the at last one first EPG. In this case, the EPG generation unit may generate the second EPG based on the generated positional information.

According to another aspect of the present invention, there is provided a computer-readable medium having embodied thereon a computer program for executing a method of generating an EPG. The method includes: receiving at least one first EPG from a content provider; detecting whether there is recording information on each of contents scheduled for the at least one first EPG; generating a second EPG using the detected recording information on each of the contents and the at least one first EPG; and transmitting the second EPG to a server.

### BRIEF DESCRIPTION OF THE DRAWINGS

The above and other exemplary features of the present invention will become more apparent by describing in detail exemplary embodiments thereof with reference to the attached drawings in which:

FIG. 1 is a diagram of an electronic program guide (EPG) generation apparatus according to an exemplary embodiment of the present invention;

FIG. 2 is a diagram of an EPG generation apparatus according to another exemplary embodiment of the present invention;

FIG. 3 is a diagram of a second EPG according to an exemplary embodiment of the present invention;

FIGS. 4A and 4B are diagrams of a second EPG according to other exemplary embodiments of the present invention;

FIG. 5 is a diagram of a second EPG according to another exemplary embodiment of the present invention;

FIG. 6 is a diagram of a microformat used for a second EPG according to an exemplary embodiment of the present invention;

FIG. 7 is a flowchart illustrating a method of generating an EPG according to an exemplary embodiment of the present invention; and

FIG. 8 is a diagram illustrating a method of generating an EPG according to an exemplary embodiment of the present invention.

### DETAILED DESCRIPTION OF EXEMPLARY EMBODIMENTS OF THE INVENTION

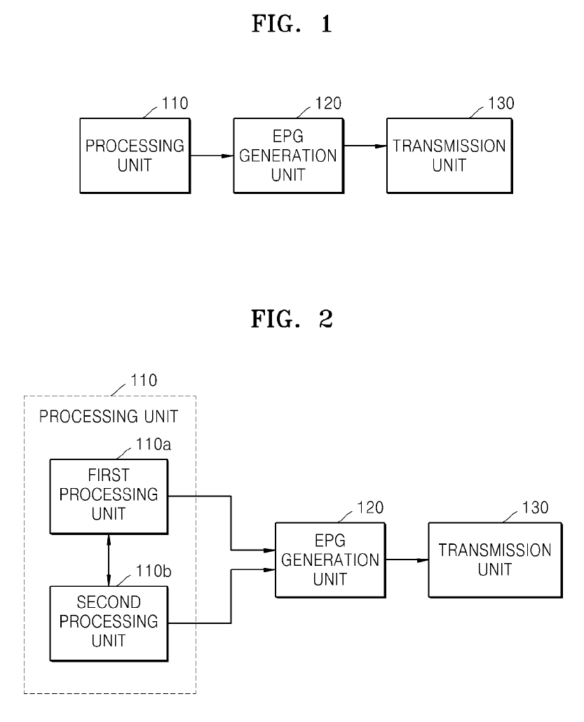

FIG. 1 is a diagram of an electronic program guide (EPG) generation apparatus according to an exemplary embodiment of the present invention.

Referring to FIG. 1, the EPG generation apparatus may include a processing unit 110, an EPG generation unit 120, and a transmission unit 130.

The processing unit 110 may receive at least one first EPG from a content provider and detect whether there is recording information on the recording of each of contents scheduled for the at least one first EPG.

The first EPG may be received in the same format in which it is stored in the content provider. The processing unit 110 may receive at least one of a first EPG configured in a hypertext markup language (HTML) format and a first EPG configured in an extensible markup language (XML) format. Also, the processing unit 110 may simultaneously receive both of the first EPG configured in the HTML format and the first EPG configured in the XML format.

However, the first EPG may be configured in one of various formats other than the HTML format and the XML format.

In this exemplary embodiment, the recording information may include information selected from the group consisting of recording completion, recording stoppage, recording cancellation, recording reservation, and reserved recording cancellation of a content and a content-recorded apparatus.

Also, the processing unit 110 may further detect whether there is additional information to be updated among additional information on contents scheduled for the at least one first EPG.

In this exemplary embodiment, the processing unit 110 may crawl information on contents scheduled for the at least one first EPG, from the content provider and search for previously uncrawled additional information or additional information, which differs from previously crawled additional information, as the additional information to be updated, based on the crawling result.

The additional information on the contents may include broadcasting schedules of the contents, actors related to the contents, and outlines of the contents.

For example, when the broadcasting schedule of a content is changed, the processing unit 110 may search for the changed broadcasting schedule as the additional information to be updated.

The EPG generation unit 120 may generate a second EPG using searched recording information of each of the contents and the at least one first EPG based on the searching result of the processing unit 110.

For example, when the processing unit 110 simultaneously receives the first EPG configured in an HTML format and the first EPG configured in an XML format, the EPG generation unit 120 may add the recording information to each of the first EPGs configured in the HTML format and the XML format and generate an integrated second EPG configured in a third format. In another exemplary embodiment, the integrated second EPG may be configured in one of the HTML format and the XML format.

As described above, the EPG generation apparatus according to the current exemplary embodiment of the present invention may generate a personalized EPG by adding recording information set by a user to the at least one first EPG provided by the content provider.

In another exemplary embodiment, the EPG generation unit 120 may generate the second EPG after the recording of at least one of contents is reserved or completed. Thereafter, the EPG generation unit 120 may back up the second EPG along with a time at which the recording is reserved or completed.

When the second EPG is backed up as described above, even if the second EPG is updated later, the same second EPG as generated at a point in time when the recording is reserved or completed may be continuously retained.

Meanwhile, if the processing unit 110 detects whether there is recording information and whether there is additional information to be updated, the second EPG may be generated using both the recording information and the additional information to be updated.

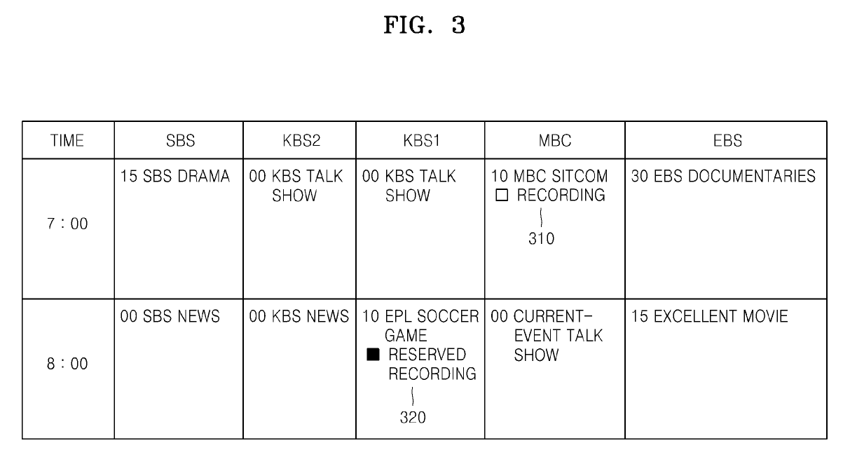

The second EPG according to exemplary embodiments of the present invention will be described later with reference to FIGS. 3 through 5.

The transmission unit 130 may transmit the second EPG to a server.

In this case, the server may be a user's exclusive server or a server shared with other people.

By transmitting the second EPG to the server, the user may access the server not only at home but also outside and check the second EPG. This becomes quite advantageous compared with a conventional case where a user can access an EPG only in the home.

FIG. 2 is a diagram of an EPG generation apparatus according to another exemplary embodiment of the present invention.

Referring to FIG. 2, the EPG generation apparatus may include a processing unit 110, an EPG generation unit 120, and a transmission unit 130 like as in FIG. 1.

However, unlike in FIG. 1, the processing unit 110 may be divided into a first processing unit 110a and a second processing unit 120a. Since operations of the EPG generation unit 120 and the transmission unit 130 are the same as described with reference to FIG. 1, a detailed description thereof will be omitted.

The first processing unit 110a may detect whether there is recording information or crawl information on contents scheduled for a first EPG from a content provider.

In this exemplary embodiment, the first processing unit 110a may further perform an operation of generating and storing the recording information.

The first and second processing units 110a and 110b may alternatively crawl the information on the contents scheduled for the first EPG from the content provider.

In this exemplary embodiment, the second processing unit 110b may further perform an operation of managing the first EPG and reproducing a content. Also, the second processing unit 110b may further perform an operation of remote-controlling a TV.

In the present exemplary embodiment, the first and second processing units 110a and 110b may alternatively crawl the information on the contents scheduled for the first EPG from the content provider in order to prevent concentration of a load on any one of the first and second processing units 110a and 110b.

For example, in the present exemplary embodiment, the first and second processing units 110a and 110b may perform other operations than the crawling operation as described above. One of the first and second processing units 110a and 110b, which spends smaller resources, may be allowed to perform the crawling operation, thereby preventing concentration of the load on any one of the first and second processing units 110a and 110b.

Here, the first processing unit 110a of FIG. 2 may be a personal video recorder (PVR), and the second processing unit 110b may be a remote controller capable of reproducing the content. Also, the EPG generation unit 120 and the transmission unit 130 may be units mounted in a TV (not shown).

In the above example, when the TV receives the recording information or information to be updated from the PVR or receives information to be updated from the remote controller, the TV may generate a second EPG using at least one of the recording information and the information to be updated, and transmit the generated second EPG to a server.

However, according to the present exemplary embodiment, unlike in FIG. 2, a single PVR may include the first processing unit 110a, the EPG generation unit 120, and the transmission unit 130, and a single remote controller may include the second processing unit 110b, the EPG generation unit 120, and the transmission unit 130.

That is, each of the PVR and the remote controller may generate the second EPG and transmit the second EPG to the server without the aid of the TV.

FIG. 3 is a diagram of a second EPG according to an exemplary embodiment of the present invention.

FIG. 3 illustrates a portion of the second EPG generated using recording information 310 and 320. The second EPG of FIG. 3 shows a schedule for contents that are broadcasted on a plurality of channels.

Referring to FIG. 3, a “white marker (□)” and text “recording completed”, which mean recording completion, are indicated as recording information 310 below a program title “MBC sitcom” broadcasted at 7:10 on the MBC channel. Also, a “black marker (▪)” and text “reserved recording”, which mean recording reservation, are indicated as recording information 320 below a program title “EPL soccer” that will be broadcasted at 8:10 on the KBS1 channel. Although both the “marker” and the “text” are indicated as the recording information in FIG. 3, in another exemplary embodiment, recording information may be indicated by only one of a “marker” and a “text”.

Also, when recording information is indicated by only a “marker”, different kinds of recording information may be allocated to different colors of “markers”.

For example, recording information may be indicated by a “red marker” during the recording of a content, while recording information may be indicated by a “yellow marker” during recording stoppage.

However, the colors of “markers” allocated to correspond to the kinds of recording information are not limited to the above example. For example, recording completion may be indicated by a “blue marker”.

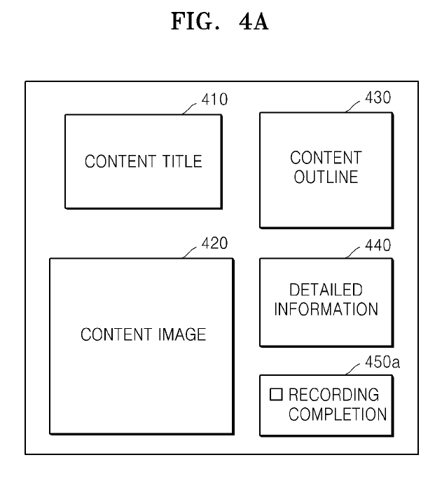

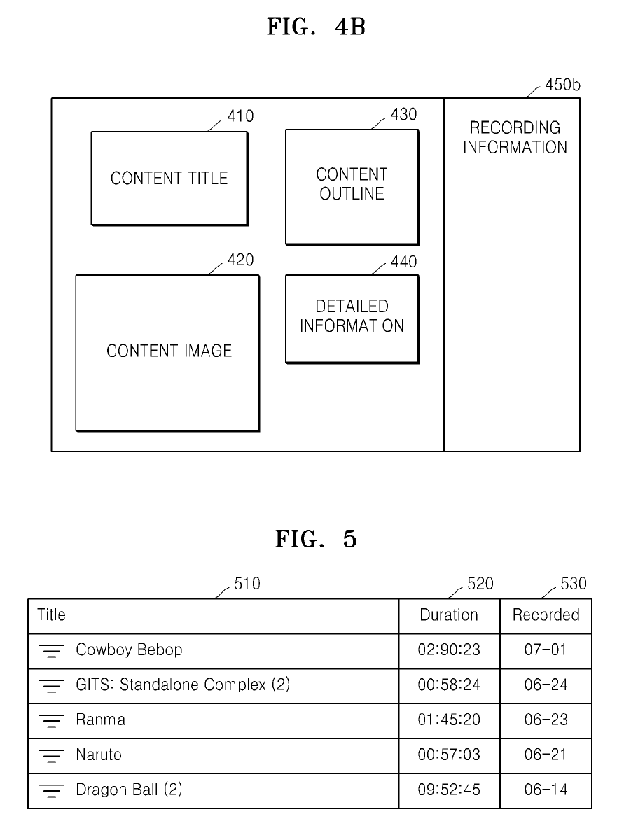

FIGS. 4A and 4B are diagrams of a second EPG according to other exemplary embodiments of the present invention.

The second EPG of FIGS. 4A and 4B are used to display additional information on a single content.

Referring to FIGS. 4A and 4B, the second EPG according to the present exemplary embodiment may include a content title 410, a content image 420, a content outline 430, detailed information 440, and recording information 450a and 450b.

In this exemplary embodiment, webpages containing more specific information on the content as additional information that is not indicated in the second EPG may be linked to the detailed information 440.

In this case, the second EPG of FIG. 4A differs from that of FIG. 4B in that the recording information 450a of FIG. 4A is inserted into a region corresponding to the second EPG, while the recording information 450b of FIG. 4B is added as a new region outside a region corresponding to the second EPG.

Thus, the recording information 450a of FIG. 4A needs to be simply indicated using a “white marker” and text “recording completion”, while the recording information 450b of FIG. 4B may be specifically indicated.

Meanwhile, when the recording information 450a and 450b are inserted into or added to the second EPG, a position of additional information on contents in the second EPG may be utilized.

For example, in the example of FIG. 4A, positional information on each of the content title 410, the content image 420, the content outline 430, and the detailed information 440 may be generated, and the recording information 450a may be inserted below the detailed information 440 based on the positional information. In this case, the positional information may include an identifier (ID) used for identifying the additional information 410 through 440 and information on the position of the additional information 410 through 440.

Also, even in the example of FIG. 3, the “white marker” and the text “recording completed” may be inserted below the program title “MBC sitcom” using positional information, and the “black marker” and the text “reserved recording” may be inserted below the program title “EPL soccer” using positional information.

As described above, when the second EPG is generated using the positional information, the speed and accuracy of an operation of identifying a content may be improved, and a position in which recording information will be inserted may be previously designated. As a result, a troublesome operation of searching for a new position in which recording information will be inserted whenever the recording information is to be inserted is not required. An EPG generation apparatus according to an exemplary embodiment of the present invention may further include a positional information generation unit (not shown) configured to generate positional information including a position of additional information on contents in the at least one first EPG.

Meanwhile, according to an exemplary embodiment, the EPG generation unit 120 may generate a second EPG based on performance of an external apparatus that will use the second EPG.

FIG. 5 is a diagram of a second EPG according to another exemplary embodiment of the present invention.

Referring to FIG. 5, only a content title 510, a content duration 520, and a recording date 530 may be indicated in the second EPG according to another exemplary embodiment of the present invention.

Unlike the second EPGs of FIGS. 4A and 4B that indicate various pieces of information using texts and images, the second EPG of FIG. 5 may indicate the content title 510, the content duration 520, and the recording date 530 only using texts. In the exemplary embodiment shown in FIG. 5, the second EPG is simply generated such that even a low-performance external apparatus can use the second EPG.

For example, a mobile apparatus may not efficiently use a second EPG when the second EPG has an excessively large capacity or is complicated. Accordingly, the mobile apparatus may need a simplified second EPG as in the exemplary embodiment of FIG. 5.

When the simplified second EPG is stored in a server, a user may receive the simplified second EPG from the server using the mobile apparatus and use the second EPG.

Meanwhile, the second EPG according to another exemplary embodiment of the present invention may be configured in a microformat.

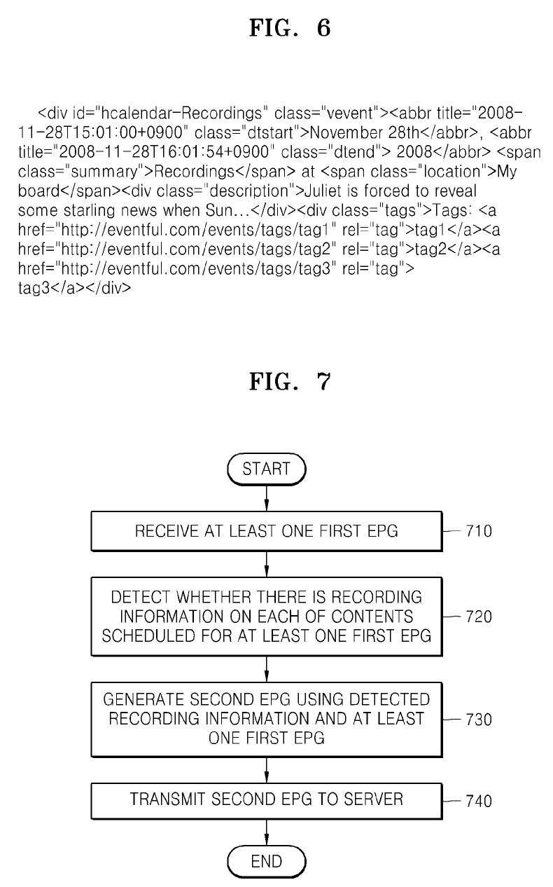

FIG. 6 is a diagram of a microformat used for a second EPG according to an exemplary embodiment of the present invention.

The microformat of FIG. 6 indicates recording information required to reserve the recording of a content and additional information on a content to be updated. As shown in FIG. 6, a class for defining each piece of the additional information may be allocated to the corresponding piece of the additional information.

Referring to FIG. 6, an identification (ID) has a class indicated by “vevent” and a value “hcalendar-Recordings”, a recording start time has a class indicated by “dtstart” and a value of three one p.m. on Nov. 28, 2008 (“2008-11-28T15:01:00”), a recording end time has a class indicated by “dtend” and a value of four one and fifty four seconds p.m. on Nov. 28, 2008 (“2008-11-28T16:01:54”), a summary has a class indicated by “summary” and a value “Recordings”, a recording location has a class indicated by “location” and a value “My board”, and an outline has a class indicated by “description” and a value “Juliet is forced to reveal some starling news when sun . . . ”. Next, tags having a class indicated by “tags” are shown along with URL addresses linked respectively to the tags.

The EPG generation unit 130 may add the microformat to the first EPG configured in an HTML format or an XML format and generate the second EPG. However, according to other exemplary embodiments, the first EPG also may be configured in a microformat.

Meanwhile, when the second EPG is configured in a microformat, the second EPG may be readily searched for the recording information and updated additional information.

Hereinafter, microformat elements applicable to exemplary embodiments of the present invention will be briefly described.

Microformat elements required to define recording reservation in a PVR:

hcard, hcalendar×2

Here, “hcard” identifies a recorded content, and “hcalendar” indicates broadcasting start and end times of a content and actual recording start and end times of the content. Since the element “hcalendar” is used twice, “×2” is added.

Microformat elements required to define a recorded content in the PVR:

hcard, hvideo, hcalendar

Here, “hcard” identifies the recorded content, “hvideo” indicates additional information on the recorded content, and “hcalendar” indicates recording start and end times of the recorded content.

Microformat elements required to describe a broadcasting program:

Station name (could use hCard's “organization-unit”)

Broadcaster (could use hCard's “organization-name”)

Description (could also be hCard's “note”)

Image URL (logo) (could use hCard's “logo”)

Category (genre) (could use hCard's “category”)

Language (used by the station rather than for the description)

Location (could use hCard's “adr” & children)

Station website (could use hCard's “url”)

Title, description, duration and the likes of hVideo

Since a microformat is described in more detail at http://microformats.org/, included hereby by reference a detailed description of the microformat elements required to describe the broadcasting program will be omitted here.

Meanwhile, in addition to the above-described microformat elements, exemplary embodiments of the present invention may employ all microformat elements required to indicate recording information and additional information on contents.

FIG. 7 is a flowchart illustrating a method of generating an EPG according to an exemplary embodiment of the present invention.

In operation 710, at least one first EPG may be received from a content provider.

In operation 720, it may be detected whether there is recording information on each of contents scheduled for the received first EPG.

In this exemplary embodiment, as described above, an operation of detecting whether there is additional information to be updated among additional information on the contents scheduled for the first EPG may be further performed.

In operation 730, a second EPG may be generated using the detected recording information on each of the contents and the at least one first EPG based on the detection result.

When detecting whether there is the recording information is followed by detecting whether there is the additional information to be updated in operation 720, the second EPG may be generated using the recording information, the additional information to be updated, and the at least one first EPG.

In operation 740, the second EPG may be transmitted to a server.

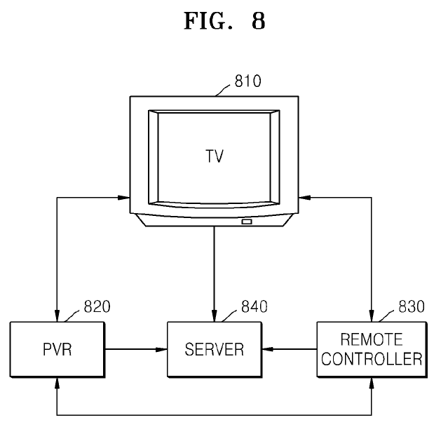

FIG. 8 is a diagram illustrating a method of generating an EPG according to an exemplary embodiment of the present invention.

A TV 810 may receive a content from a content provider and reproduce the received content. Also, the TV 810 may read a content stored in a PVR 820 and reproduce the stored content.

The PVR 820 may record a content, receive at least one first EPG from the content provider, and generate and store recording information on contents scheduled for the at least one first EPG.

A remote controller 830 may remotely control the TV 810 and manage the at least one first EPG provided by the content provider. The management of the first EPG may include receiving and outputting the first EPG. Also, it is assumed in the present exemplary embodiment that the remote controller 830 can reproduce contents by itself.

In addition to the above-described intrinsic functions, the PVR 820 and remote controller 830 of FIG. 8 may generate a second EPG and transmit the second EPG to a server 840.

More specifically, the PVR 820 may detect whether there is recording information stored therein in connection with contents scheduled for the at least one first EPG provided by the content provider. In this case, the PVR 820 may be a ViXS system. In this case, the recording information may be stored in an external storage apparatus connected to the ViXS system so that the ViXS system can detect whether the recording information is in the external storage apparatus.

When the recording information is detected, the PVR 820 may generate the second EPG using the recording information and transmit the second EPG to the server 840.

One of the PVR 820 and the remote controller 830 may crawl information on the contents scheduled for the at least one first EPG from the content provider in order to detect whether there is additional information to be updated among additional information on the contents scheduled for the at least one first EPG.

That is, in the present exemplary embodiment, only one of the PVR 820 and the remote controller 830, but not both, may perform a crawling operation.

The crawling operation may be performed by one of the remote controller 830 and the PVR 820, which performs operations to consume smaller resources at present.

For example, when the PVR 820 records a content received from the content provider or transmits a recorded content to the remote controller 830, the PVR 820 and the remote controller 830 may exchange messages with each other so that the remote controller 830 can perform the crawling operation.

Also, while a user is watching the TV 810, the remote controller 830 should remotely control the TV 810 or reproduce a content so that the PVR 820 may perform the crawling operation.

When one of the PVR 820 and the remote controller 830 consumes many resources during the crawling operation, the other should perform the remaining crawling operation. In this exemplary embodiment, one of the PVR 820 and the remote controller 830 that performs the crawling operation first may hand over previously crawled information and information required for the crawling operation to the other.

The information required for the crawling operation may include URL addresses of webpages to be crawled in order to detect whether there is the additional information to be updated and information required to discriminate presently crawled information and uncrawled information in the webpages.

Finally, when one of the PVR 820 and the remote controller 830 finishes the crawling operation to detect the additional information to be updated, one of the PVR 820 and the remote controller 830 may generate the second EPG using the additional information to be updated and transmit the second EPG to the server 840.

Meanwhile, the crawling operation may be set to get started when the recording of the at least one of the contents scheduled for the first EPG is reserved or completed.

In another exemplary embodiment, in addition to the method of generating the second EPG using the recording information and the additional information to be updated, a method of generating a second EPG using snap shots captured during recording of a content may be assumed.

For example, when the PVR 820 finishes recording a predetermined content, the PVR 820 may generate a second EPG by inserting snap shots captured during the recording of the content into a first EPG and transmit the generated second EPG to the server 840.

In another exemplary embodiment, when the TV 810 receives recording information or information to be updated from the PVR 820 or receives information to be updated from the remote controller 830, the TV 810 may generate a second EPG using at least one of the received recording information and the information to be updated and directly transmit the generated second EPG to the server 840.

The exemplary embodiments of the present invention can be written as computer programs and can be implemented in general-use digital computers that execute the programs using a tangible or transient computer readable recording medium. Examples of tangible computer readable recording medium include magnetic storage media (e.g., ROM, floppy disks, hard disks, etc.), and optical recording media (e.g., CD-ROMs, or DVDs). Examples of transient computer readable medium include storage media such as carrier waves (e.g., transmission through the Internet).

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of generating a personalized electronic program guide (EPG), the method comprising:
receiving at least one first EPG of scheduled contents from a content provider;
detecting whether there is recording information on each of the scheduled contents;
generating a second EPG using the detected recording information and the at least one first EPG, if the recording information is detected; and
transmitting the second EPG to a server.

2. The method of claim 1, further comprising detecting whether there is additional information to be updated among additional information on the scheduled contents,
wherein the generating the second EPG comprises generating the second EPG using the recording information and the additional information to be updated, if the additional information to be updated is detected.

3. The method of claim 2, wherein the detecting whether there is the additional information to be updated comprises:
crawling for information on the scheduled contents from the content provider; and
searching for previously uncrawled additional information or additional information, which differs from previously crawled additional information, as the additional information to be updated, based on a result of the crawling.

4. The method of claim 3, wherein the detecting whether there is the recording information is performed using a first processing unit, and the crawling for information on the scheduled contents from the content provider is performed using one of the first processing unit and a second processing unit.

5. The method of claim 4, wherein the first processing unit generates and stores the recording information, and the second processing unit manages the at least one first EPG and reproduces the scheduled contents,
wherein the crawling for information on the scheduled contents from the content provider is performed by one of the first and second processing units, which performs operations to consume smaller resources at present.

6. The method of claim 3, wherein the crawling for information on the scheduled contents from the content provider is performed after recording of at least one of the scheduled contents is reserved or completed.

7. The method of claim 1, wherein at least one EPG of the at least one first EPG and the second EPG is configured in a microformat, and
wherein the detecting whether there is the recording information is performed based on the microformat included in the at least one first EPG.

8. The method of claim 1, wherein the generating the second EPG comprises inserting at least one of a marker and text, which indicates the recording information, into the at least one first EPG or adding an addition region containing the recording information to the at least one first EPG.

9. The method of claim 8, further comprising generating positional information including a position of additional information on the scheduled contents in the at least one first EPG,
wherein the generating the second EPG is performed based on the generated positional information.

10. The method of claim 1, wherein the generating the second EPG is performed based on performance of an external apparatus that will use the second EPG.

11. The method of claim 1, wherein the recording information includes information on at least one selected from the group consisting of recording completion, recording stoppage, recording cancellation, recording reservation, and reserved recording cancellation of a content and a content-recorded apparatus.

12. The method of claim 1, wherein the receiving the at least one first EPG comprises receiving at least one of a first EPG configured in a hypertext markup language format and a first EPG configured in an extensible markup language format.

13. The method of claim 1, wherein the generating the second EPG is performed after recording of the at least one of the scheduled contents is reserved or completed,
the method further comprising backing up the second EPG along with a time at which the recording is reserved or completed after the generating the second EPG.

14. An electronic program guide (EPG) generation apparatus for providing a personalized EPG, the apparatus comprising:
a processing unit that receives at least one first EPG of scheduled contents from a content provider and detects whether there is recording information on each of the scheduled contents;
an EPG generation unit that generates a second EPG using the detected recording information and the at least one first EPG, if the recording information is detected; and
a transmission unit that transmits the second EPG to a server.

15. The apparatus of claim 14, wherein the processing unit detects whether there is additional information to be updated among additional information on the scheduled contents,
wherein the second EPG is generated using the recording information and the additional information to be updated, if the additional information to be updated is detected.

16. The apparatus of claim 15, wherein the processing unit crawls for information on the scheduled contents from the content provider and searches for previously uncrawled additional information or additional information, which differs from previously crawled additional information, as the additional information to be updated, based on a result of the crawling.

17. The apparatus of claim 16, wherein the processing unit comprises:
a first processing unit that detects whether there is the recording information or crawls for the information on the scheduled contents from the content provider; and
a second processing unit that crawls for the information on the scheduled contents from the content provider, wherein the crawling for the information on the scheduled contents from the content provider is performed by one of the first processing unit and the second processing unit.

18. The apparatus of claim 17, wherein the first processing unit generates and stores the recording information, and the second processing unit manages the at least one first EPG and reproduces the scheduled contents,
wherein the crawling for the information on the scheduled contents from the content provider is performed by one of the first and second processing units, which performs operations to consume smaller resources at present.

19. The apparatus of claim 16, wherein the processing unit crawls for the information on the scheduled contents from the content provider after recording of at least one of the scheduled contents is reserved or completed.

20. The apparatus of claim 14, wherein at least one EPG of the at least one first EPG and the second EPG is configured in a microformat, and
wherein the processing unit detects whether there is the recording information based on the microformat included in the at least one first EPG.

21. The apparatus of claim 14, wherein the EPG generation unit generates the second EPG by inserting at least one of a marker and text, which indicates the recording information, into the at least one first EPG or adding an addition region containing the recording information to the at least one first EPG.

22. The apparatus of claim 21, further comprising a positional information generation unit that generates positional information including a position of additional information on the scheduled contents in the at least one first EPG,
wherein the EPG generation unit generates the second EPG based on the generated positional information.

23. The apparatus of claim 14, wherein the EPG generation unit generates the second EPG based on performance of an external apparatus that will use the second EPG.

24. The apparatus of claim 14, wherein the recording information includes information on at least one selected from the group consisting of recording completion, recording stoppage, recording cancellation, recording reservation, and reserved recording cancellation of a content and a content-recorded apparatus.

25. The apparatus of claim 14, wherein the processing unit receives at least one of a first EPG configured in a hypertext markup language format and a first EPG configured in an extensible markup language format.

26. The apparatus of claim 14, wherein the EPG generation unit generates the second EPG after recording of the at least one of the scheduled contents is reserved or completed and backs up the generated second EPG along with a time at which the recording is reserved or completed.

27. A computer-readable medium having embodied thereon a computer program for executing the method of claim 1.
